(19) United States
(12) Patent Application Publication
(10) Pub. No.: US 2026/0254809 A1
(43) Pub. Date: Aug. 27, 2026

(54) SYSTEM AND METHOD FOR PROVIDING LEARNING CURATION SERVICE USING LEARNING MAP-LINKED OPEN BADGE

(71) Applicant: SWEMPIRE CO., LTD., Goyang-si (KR)

(72) Inventor: Myoung Soo CHOI, Goyang-si (KR)

(73) Assignee: SWEMPIRE CO., LTD., Goyang-si (KR)

(21) Appl. No.: 19/652,105

(22) Filed: Apr. 20, 2026

Related U.S. Application Data
(63) Continuation of application No. PCT/KR2025/013239, filed on Aug. 29, 2025.

(30) Foreign Application Priority Data
Sep. 27, 2024 (KR) 10-2024-0131726

(51) Int. Cl. H04L 9/40; G06Q 20/36; G06Q 50/20

(52) U.S. Cl. CPC H04L 63/083; G06Q 20/36; G06Q 50/205

(57) ABSTRACT

Provided is a system and a method for providing a learning curation service using a learning map-linked open badge that reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

### CROSS-REFERENCE TO RELATED APPLICATIONS

The present application is a continuation of International Patent Application No.PCT/KR2025/013239, filed on Aug. 29, 2025, which is based upon and claims the benefit of priority to Korean Patent Application No. 10-2024-0131726 filed on Sep. 27, 2024. The disclosures of the above-listed applications are hereby incorporated by reference herein in their entirety.

### BACKGROUND

Embodiments of the present disclosure described herein relate to a system and a method for providing a learning curation service using a learning map-linked open badge.

With the development of Internet services, most people use, through the Internet, numerous online services such as government institutions, educational institutions, medical institutions, telecommunication companies, financial companies, passenger companies, asset management, credit information, portals, social network services (SNS), games, shopping, ticketing, courier, electronic voting, etc.

Accordingly, users who intend to utilize these services need to sign up as members by entering personal information, including their real name, or to authenticate themselves as registered users by entering a specific ID and a password. However, because it is quite cumbersome to repeat this authentication process at a plurality of sites, a method called simple authentication has been recently developed to easily conduct financial transactions on the Internet by logging in easily.

User authentication has been conventionally performed by using a centralized identify (ID) system. Generally, a public certificate and program Active X for using the public certificate or a separate application (App) for performing authentication has been installed, and then authentication has been made through the program or application.

However, personal information may be leaked or abused in the centralized identity verifying system.

Moreover, when the user's identity is verified by using the program or application, a separate program needs to be installed. Besides, a new authentication application or a new authentication program may not be compatible with existing applications or programs, and thus the user identity may not be smoothly verified.

Nowadays, a decentralized identifiers (DID) technology, which allows users to verify their identities through an issuer, is attracting attention.

In the meantime, an open badge is nowadays emerging as a new digital credentialing method using a blockchain technology. The open badge includes metadata of each individual's learning history, skills, knowledge, honor, experience, and capabilities in a unique image. The reliability of results may be improved by capturing and recognizing a wide range of learning results and verifying them by using a blockchain. In other words, the open badge is a standardized framework capable of sharing a badge, and has qualifications for evaluation, issuance security, and authentication system, thereby securing the reliability of proof.

Accordingly, there is a need to develop a technology that allows users (learners) to prove their capabilities acquired through education, learning, and testing provided by educational institutions (learning institutions) through open badges, and also to expand those capabilities by utilizing those open badges.

### SUMMARY

Embodiments of the present disclosure provide a system and a method for providing a learning curation service using a learning map-linked open badge that may reduce a user's trouble of generally visiting an educational institution or the educational institution's homepage to obtain a certificate, an educational qualification, or the like and submitting it directly to consumers (submitting institutions), by issuing and providing a blockchain-based open badge linked to a learning map such that the user (learner) is capable of proving his/her qualifications acquired through education, learning, examination, or the like provided by the educational institution (learning institution), thereby reducing the time required for issuance and submission as well as incidental costs while security is guaranteed.

Embodiments of the present disclosure provide a system and a method for providing a learning curation service using a learning map-linked open badge that may allow a user to easily check the user's fragmented history data by integrating and managing at least one open badge issued to the user, and may allow the user to post the fragmented history data to at least one SNS, thereby quickly and easily utilize the history data for employment or advancement.

Embodiments of the present disclosure provide a system and a method for providing a learning curation service using a learning map-linked open badge that may allow a user to gradually and systematically expand his/her capabilities by providing a learning curation service using an open badge based on a learning map.

Problems to be solved by the present disclosure are not limited to the problems mentioned above, and other problems not mentioned will be apparent by those skilled in the art from the following description.

According to an embodiment, a learning curation service providing system using a learning map-linked open badge includes a first institutional terminal that provides a learning service to a user terminal, and creates or updates history information about a user by receiving learning performance result information from the user terminal, the user terminal that performs learning through a learning service provided by the first institutional terminal, and stores an open badge issued upon requesting a service server to issue an open badge for the learning, and a service server that, when an open badge issuance request is received from the user terminal, determines whether to issue the open badge, by determining whether the user has an issuance qualification for the open badge requested to be issued, when open badge issuance is completed, records and manages the issued open badge on a decentralized identifiers (DID) electronic wallet of the user registered on a blockchain, and generates and provides learning curation information about the issued open badge based on pre-stored curriculum information.

According to an embodiment, a method performed by a device and used to provide a learning curation service using a learning map-linked open badge includes when a corresponding user completely performs learning based on a learning service provided by a first institutional terminal, transmitting, by a user terminal, learning performance result information about the learning to a first institutional terminal, generating or updating, by the first institutional terminal, history information about the corresponding user based on the learning performance result information, when an open badge issuance request for the learning is received from the user terminal, determining, by a service server, whether the corresponding user has an issuance qualification for the open badge requested to be issued, through the first institutional terminal, when the determination result indicates that the corresponding user has the issuance qualification for the open badge requested to be issued, issuing, by the service server, an open badge for the learning based on badge issuance data for the corresponding user, recording, by the service server, the issued open badge in a DID electronic wallet of the corresponding user registered on a blockchain, and generating and providing, by the service server, learning curation information about the issued open badge based on pre-stored curriculum information.

Besides, a computer program stored in a computer-readable recording medium for executing a method to implement the present disclosure may be further provided.

In addition, a computer-readable recording medium for recording a computer program for performing the method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a diagram showing a network structure of a learning curation service providing system using a learning map-linked open badge, according to an embodiment of the present disclosure;

FIG. 2 is a diagram showing a procedure for providing a learning curation service using a learning map-linked open badge, according to an embodiment of the present disclosure;

FIG. 3 is a flowchart illustrating an operation of a learning curation service providing system using a learning map-linked open badge, according to an embodiment of the present disclosure;

FIG. 4 is a diagram illustrating the concept of a learning map-linked open badge, according to an embodiment of the present disclosure;

FIG. 5 is a diagram showing a configuration of a service server that provides a learning curation service using a learning map-linked open badge, according to an embodiment of the present disclosure;

FIG. 6 is a flowchart illustrating a method for providing a learning curation service using a learning map-linked open badge, according to an embodiment of the present disclosure;

FIG. 7 is a diagram showing a specific operation for issuing an open badge in a method for providing a learning curation service using a learning map-linked open badge, according to an embodiment of the present disclosure;

FIG. 8 is a diagram illustrating a specific operation for generating learning curation information in a method for providing a learning curation service using a learning map-linked open badge, according to an embodiment of the present disclosure;

FIG. 9 is a diagram showing a detailed structure of a competency framework corresponding to each curriculum, according to an embodiment of the present disclosure;

FIG. 10 is a diagram showing an example of a competency framework corresponding to a specific curriculum, according to an embodiment of the present disclosure; and

FIG. 11 is a diagram showing a specific operation for performing DID verification in a method for providing a learning curation service using a learning map-linked open badge, according to an embodiment of the present disclosure.

### DETAILED DESCRIPTION

The above and other aspects, features and advantages of the present disclosure will become apparent from the following description of the following embodiments given in conjunction with the accompanying drawings. The present disclosure, however, may be embodied in various different forms, and should not be construed as being limited only to the illustrated embodiments. Rather, these embodiments are provided as examples so that the present disclosure will be thorough and complete, and will fully convey the scope of the present disclosure to those skilled in the art. The present disclosure may be defined by the scope of the claims.

The terms used herein are provided to describe embodiments, not intended to limit the present disclosure. In the specification, the singular forms include plural forms unless particularly mentioned. The terms “comprises” and/or “comprising” used herein do not exclude the presence or addition of one or more other components, in addition to the aforementioned components. The same reference numerals denote the same components throughout the specification. As used herein, the term “and/or” includes each of the associated components and all combinations of one or more of the associated components. It will be understood that, although the terms “first”, “second”, etc., may be used herein to describe various components, these components should not be limited by these terms. These terms are only used to distinguish one component from another component. Thus, a first component that is discussed below could be termed a second component without departing from the technical idea of the present disclosure.

Unless otherwise defined, all terms (including technical and scientific terms) used herein have the same meaning as commonly understood by those skilled in the art to which the present disclosure pertains. Moreover, terms, such as those defined in commonly used dictionaries, should not be interpreted in an idealized or overly formal sense unless expressly so defined herein.

The same reference numerals denote the same elements throughout the present disclosure. The present disclosure does not describe all elements of embodiments. Well-known content in a technical field, to which the present disclosure belongs, or redundant content in which embodiments are the same as one another will be omitted. The term “unit” or “module” used herein may refer to software or hardware such as field programmable gate array (FPGA) or application specific integrated circuit (ASIC), and the “unit” or “module” may perform some functions. However, the “unit” or “module” may be not limited to software or hardware. The “unit” or “module” may be configured to exist in an addressable storage medium or may be configured to operate one or more processors. Therefore, as an example, “units” or “module” may include various elements such as software elements, object-oriented software elements, class elements, and task elements, processes, functions, attributes, procedures, subroutines, program code segments, drivers, firmware, microcodes, circuits, data, databases, data structures, tables, arrays, and variables. Functions provided in “units” or “modules” and elements may be combined into a smaller number of “units” or “modules” and elements or may be divided into additional “units” or “modules” and elements.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, definitions of terms used in the description are as follows.

In the present disclosure, the description is limited to a service server 300. However, the present disclosure may further include a server, a computer, and/or a portable terminal, or may be in a form of any one thereof.

Here, the server may be a server that processes information by communicating with an external device and may include an application server, a computing server, a database server, a file server, a game server, a mail server, a proxy server, and a web server.

For example, the computer may include a notebook computer, a desktop computer, a laptop computer, a tablet PC, a slate PC, and the like, which are equipped with a web browser.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Hereinafter, operating principles and embodiments of the present disclosure will be described with reference to the accompanying drawings.

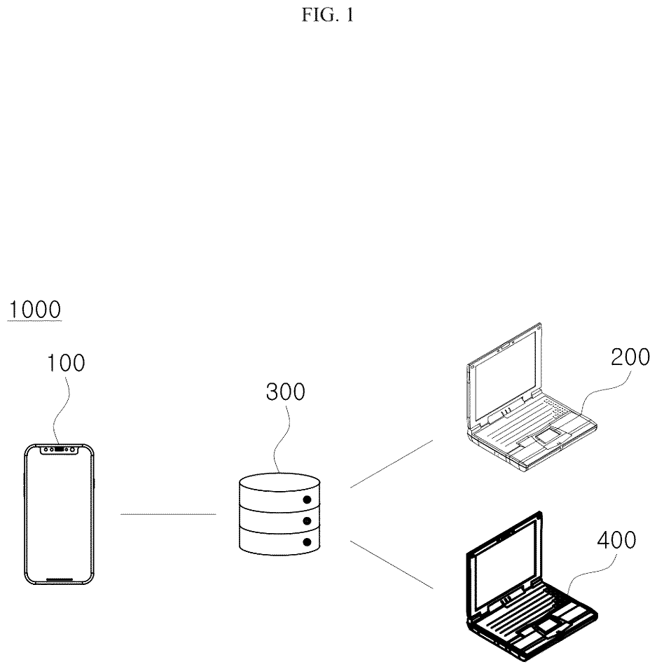

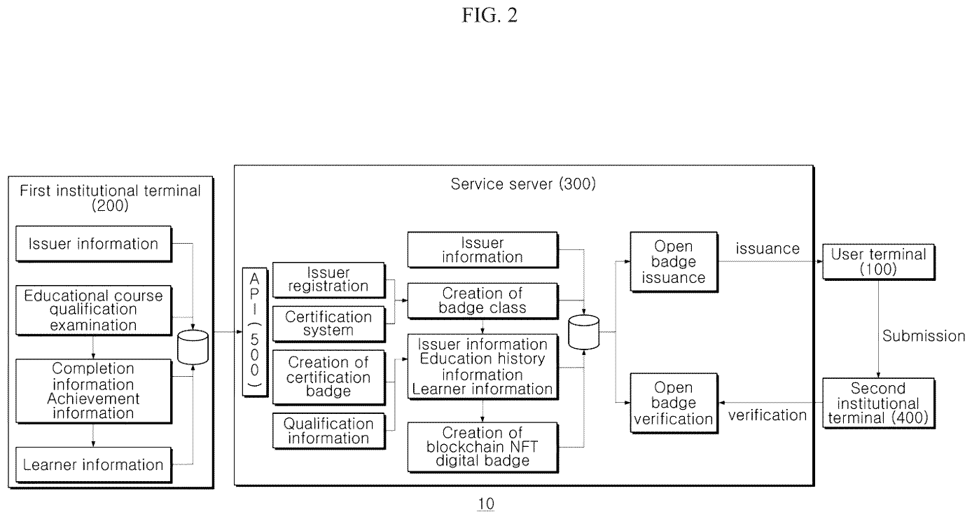

FIG. 1 is a diagram showing a network structure of a learning curation service providing system using a learning map-linked open badge, according to an embodiment of the present disclosure. FIG. 2 is a diagram showing a procedure for providing a learning curation service using a learning map-linked open badge, according to an embodiment of the present disclosure.

Referring to FIG. 1, a learning curation service providing system using a learning map-linked open badge (hereinafter referred to as a ‘service providing system’) 1000 according to an embodiment of the present disclosure may include a user terminal 100, a first institutional terminal 200, a learning curation service providing device using a learning map-linked open badge (hereinafter referred to as a ‘service server’) 300, and a second institutional terminal 400. Here, the one first institutional terminal 200 and the one second institutional terminal 400 are described, but this is only for convenience of description. The number or type thereof is not limited thereto. In the meantime, for convenience of description, a learning institution is described by way of example. However, the present disclosure may be applied to, but is not limited to, any other organization that provides users with courses for obtaining qualifications for learning, education, work, or the like.

The user terminal 100 is a terminal of a user (recipient) who obtains qualifications related to learning, education, work, or the like, by performing the learning, the education, the work, or the like, which is provided by at least one first institution based on the first institutional terminals 200. To receive a learning curation service, the user terminal 100 registers an issuer's distributed ID information on a blockchain (trusted ID storage) through the service server 300 (i.e., DID user registration). In this case, when DID user registration is performed, a user (i.e., a user's identity) may be verified through one of a plurality of authentication methods while the initial distributed ID is issued. Here, the plurality of authentication methods may correspond to integrated authentication and may include at least one of biometric authentication, PIN numbers, and patterns.

In the meantime, when a user holding the user terminal 100 obtains qualifications and then requests the service server 300 to issue an open badge including the assertion of performance information as a result of the performance of learning, education, work, or the like provided by the first institutional terminal 200, the open badge is issued from the service server 300 in response to the request. Meanwhile, the issued open badge may be presented or displayed to the second institutional terminal 400, which is a demanding terminal, at the request of the user terminal 100.

In the meantime, the first institutional terminal 200 may be a device or server equipped (installed) in a learning institution, and may provide a separate web page or platform (application) to provide the learning service. In other words, the first institutional terminal 200 may build and provide a separate web page or platform (application), the first institutional terminal 200 provides the requested learning service to the at least one user terminal 100 registered for the learning service based on the web page or platform.

The first institutional terminal 200 stores and manages not only the user's user information, but also history information about learning. Here, the user information may include at least one of a user's name, age, gender, address, contact information, and academic background. The history information may include at least one of login information including a login history, admission information (year of admission, department, student number, etc.), major information, lecture information (semester information, lecture codes, classification codes, course registration information, curriculum, lecture content, completion statuses, credits earned, etc.), learning course information (student numbers, course codes, completion statuses, etc.), inquiry information (question name/question content, response name/response content, etc.), assignment information, grade information, and evaluation information (evaluation results of proficiency, ability, talent, etc.) about the user.

Moreover, the first institutional terminal 200 provides the corresponding learning service at the request of the user terminal 100. When the user completes the learning course for a specific learning through the user terminal 100, the first institutional terminal 200 receives the learning performance result and then grants the user the qualification corresponding to the learning course. In this case, on the basis of the learning performance result, the first institutional terminal 200 may newly create history information about the user or may update the existing history information.

Accordingly, when the user terminal 100, the service server 300, and the demanding institution 400 are directly or indirectly requested to identify the eligibility of the user or to identify the eligibility for receiving an open badge, the first institutional terminal 200 may identify and answer the eligibility based on the user information and the history information. In this case, the first institutional terminal 200 may determine whether the corresponding user satisfies requirements for obtaining an open badge, based on the pre-stored criteria. When the requirements are satisfied, the first institutional terminal 200 may provide the service server 300 with badge issuance data obtained by extracting some history information from the history information. However, this is only an example, and the history information about the user may be provided as it is to the service server 300 without the need to extract the badge issuance data from the history information.

Here, the at least one or more first institutional terminals 200 may be provided. While each of the first institutional terminals 200 is linked (connected) to the service server 300 through an application programming interface (API), the system, format, or the like for qualifications, certificates, or the like that is capable of being issued by each first institution (a learning institution, an educational institution, or the like) may be stored together.

In the meantime, the service server 300 may perform an operation of managing badge issuance data, registering and managing a badge issuance institution, providing a badge standard guide, building a badge operating framework, verifying a badge issuance institution and a badge issuance history, and providing badge issuance data information. Here, the badge issuance data may be data for badge issuance, and may be data extracted from the history information stored and managed by the first institutional terminal 200. However, this is only one example, and the service server 300 may receive the user's history information as it is, and is not limited thereto.

The service server 300 issues an open badge based on the badge issuance data or the history information, and then registers the badge issuance data on a blockchain so as to be registered. In this case, the badge issuance data or the history information includes a public key used to sign the assertion of the first institutional terminal 200. The public key may be used later for DID verification. Additionally, the service server 300 may revoke an open badge. In this case, the required method of revoking an open badge differs based on whether the assertion is a hosted assertion or a signed assertion.

In the meantime, when issuing an open badge, the service server 300 issues the open badge by identifying (measuring) at least one of the corresponding user's learning chunks, proficiency, competency, and talent based on the badge issuance data or the history information.

In other words, the open badge may include metadata such as the user's performance and competency within the badge image, and may be verified anytime, anywhere. Here, the metadata may be recorded on a conventional digital badge and may be based on the minimum metadata. For example, necessary metadata may include at least one of first institution data (an issuer name, an issuer address, an issuer description, whether the issuer is accredited, or the like), a badge class (the name of a course, whether the course is accredited, the feature/level of the accredited course, a course category, nature/level of the course, completion/qualification acquisition criteria, a qualification quality assurance type, or the like), acquisition data (completion/acquisition qualification, badge issuance date, badge expiration date, assessment type, a learning activity participation type, or the like), an earner (an earner name, earner information, or the like), and verification information (verification URL, or the like). Optional metadata may include at least one of additional information about an issuer, course completion criteria/cycles, evidence URL, withdrawal/reasons for withdrawal, a possibility of integration with other badges, other service purpose information, prerequisite learning requirements for course registration, assessment courses, scores earned, connectivity with other courses, characteristics of a qualification created by integration/accumulation with other courses, and a location on a learning portfolio/career path.

When there is a request from an earner or demander due to the closure of the issuer or the loss or damage of data, the metadata may be used to verify the data.

Besides, the service server 300 stores and searches for smart contract-based blockchain data for an open badge. In this case, data search performance may be improved by generating actual data blocks in one file format by using a data block allocation table linked to a data registration transaction, and caching meta information of data and the data block allocation table. Furthermore, the data search performance may be improved by creating actual data blocks in one file format by using a data block allocation table linked to a data registration transaction, and caching data meta information and the data block allocation table. To this end, data may be encrypted based on unique information generated by the smart contract, and the encrypted data may be applied such that a decryption key is automatically obtained depending on access control permissions.

To this end, the service server 300 may build and provide a separate web page or platform (application). Each device (a user terminal, an issuing institutional terminal, a demand institutional terminal, or the like) registered for a learning curation service may receive the learning curation service based on the web page or platform (application).

A dashboard for each user may be implemented on this web page or platform. At least one open badge (i.e., DID status) issued to each user may be configured on the dashboard in the form of a portfolio. In this way, the user may identify various types of information about at least one open badge issued to him/her through his/her DID status by executing a web page or platform through the user terminal 100.

The service server 300 may perform DID registration, open badge issuance, DID verification, or the like on a user based on an API 500 linked in advance.

Meanwhile, the service server 300 generates and provides learning curation information for open badges issued based on pre-stored curriculum information. In this case, the service server 300 may process the learning curation information at the request of the user terminal 100, or may process it immediately after the open badge is issued. Accordingly, the service server 300 may independently provide the learning curation information, or it may be included in the open badge issuance information. The method or form of provision is not limited thereto.

In the meantime, the second institutional terminal 400 may be a device (terminal) installed in a consumer. When the open badge is submitted or displayed from the user terminal 100, the second institutional terminal 400 may request the service server 300 to verify an assertion, which is digitally signed in the open badge, based on a public key such that DID verification is performed.

Accordingly, when the verification from the service server 300 is completed, it may be determined whether to accredit the user's qualification for the open badge, based on the verification result.

In the meantime, the user terminal 100, the first institutional terminal 200, and the second institutional terminal 400 may be a computer, an ultra-mobile PC (UMPC), a workstation, a net-book, personal digital assistants (PDA), a portable computer, a web tablet, a wireless phone, a mobile phone, a smart phone, a pad, a smart watch, a wearable terminal, an e-book, a portable multimedia player (PMP), a portable game console, a navigation device, a black box or digital camera, other mobile communication terminals, or the like, on which a user/a first institution (an educational institution, a learning institution, or the like)/a consumer (a demander, a submission location, or the like) is capable of installing and executing a plurality of desired application programs (i.e., applications). In this case, the user terminal 100, the first institutional terminal 200, and the second institutional terminal 400 may be provided in various forms and is not limited thereto.

As described above, a service providing system 1000 according to an embodiment of the present disclosure may be implemented through data transmission and reception between the user terminal 100, the first institutional terminal 200, the service server 300, and the second institutional terminal 400.

In the meantime, although not illustrated in FIGS. 1 and 2, the service providing system 1000 may be connected to other external servers. For example, the service providing system 1000 may further include at least one learning server, at least one search server, and the like. For example, the learning server may be a server for providing a learning service on an online or offline basis, and the search server may be a server for providing an information search service.

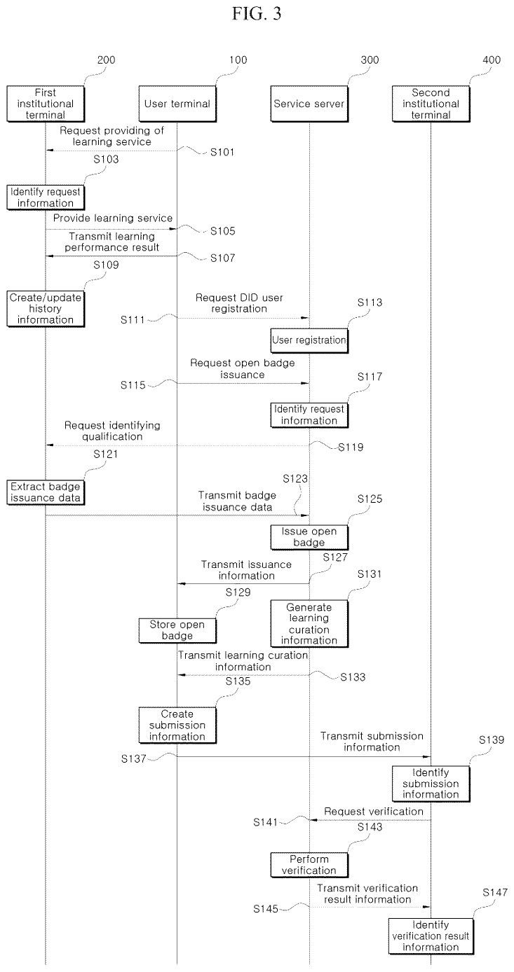

FIG. 3 is a flowchart illustrating an operation of a learning curation service providing system using a learning map-linked open badge, according to an embodiment of the present disclosure.

Referring to FIG. 3, the user terminal 100 transmits a learning service providing request to the first institutional terminal 200 to receive a learning service by a first institution (S101). In this case, the learning service providing request may be a request for subscribing to the learning service when a user is a new user. When the user is an existing subscribed user, the learning service providing request may be a request for providing specific learning among at least one learning service.

Next, the first institutional terminal 200 identifies request information in step S101 (S103). After the first institutional terminal 200 determines whether to provide the learning service by determining whether the user has access permissions, the first institutional terminal 200 provides the requested learning service only to the accessible user (S105).

Next, the user terminal 100 performs the learning service provided by the first institutional terminal 200. When the corresponding learning service is completely performed, the user terminal 100 transmits the learning performance result to the first institutional terminal 200 (S107).

Next, on the basis of the learning performance result received in step S107, the first institutional terminal 200 newly creates history information for the corresponding user or updates the previously created history information (S109).

Afterward, the user terminal 100 transmits a DID user registration request to the service server 300 to receive a learning curation service (S111), and performs DID user registration by registering the user's distributed ID information on the trusted ID storage (i.e., a blockchain) of the service server 300 (S113). In this case, a DID electronic wallet for the corresponding user may be created.

Next, when the user terminal 100 intends to receive an open badge, the user terminal 100 transmits the open badge issuance request to the service server 300 (S115). In this case, although not shown in FIG. 3, when the user terminal 100 requests open badge issuance, the user terminal 100 may receive at least one open badge, which is capable of being issued by the service server 300, in a list form (hereinafter referred to as an “issuable open badge list′) from the service server 300. In other words, a user may transmit an issuance request for any open badge by selecting the open badge from the list. To this end, the service server 300 may perform an operation of registering the at least one first institutional terminals 200 in advance, and may identify at least one open badge, which is capable of being issued to each user, through history information of each user from the registered the at least one first institutional terminals 200. In the meantime, in another embodiment, the service server 300 may support the acquisition of additional open badge issuance qualifications by recommending issuing an issuable open badge in addition to the open badge requested by the user, or recommending other learning related to the previously issued open badge.

Next, the service server 300 identifies the request information in step S115 (S117), transmits a request for a qualification check to the first institutional terminal 200, and requests the first institutional terminal 200 to identify the user's qualification for the open badge for which the issuance is requested (S119).

Next, the first institutional terminal 200 identifies the user's history information depending on the request in step S119, extracts data (i.e., badge issuance data) for issuing a badge from the history information (S121), and transmits the badge issuance data to the service server 300 (S123).

Next, the service server 300 issues the open badge, of which the issuance is requested, based on the badge issuance data obtained in step S123 (S125) and transmits issuance information including the issued open badge to the user terminal 100 (S127).

Accordingly, the user terminal 100 may store the open badge included in the issuance information (S129) and may post the open badge on at least one SNS installed on the user terminal 100 as needed.

Next, the service server 300 generates learning curation information using the open badge issued in step S125 (S131) and provides it to the user terminal 100.

Accordingly, based on the learning curation information received through the user terminal 100, the user is capable of sequentially learning at least one other learning related to the learning that he/she has already completed.

Afterward, the user terminal 100 generates submission information including the open badge stored in step S129 (S135) to submit the open badge corresponding to the corresponding qualification to a second institution, by which the user desires to be credentialed, and transmits the submission information to the second institutional terminal 400 (S137).

Next, the second institutional terminal 400 identifies the submission information (S139), and requests the service server 300 to verify the open badge included in the submission information (S141).

Accordingly, the service server 300 verifies the open badge depending on the request in step S141 (S143), and generates verification result information including the verification result and transmits the verification result information to the second institutional terminal 400 (S145).

Next, the second institutional terminal 400 determines whether to credential the user's qualification by identifying the verification result information received in step S145 (S147).

In the meantime, steps S131 to S133 illustrated in FIG. 3 may be performed at any time after step S125, and the provision conditions may be set in advance by an administrator or a user of the service server 300 and provided automatically, or may be provided at a request of the user through the user terminal 100. That is, steps S131 to S133 may be performed independently after the open badge is issued.

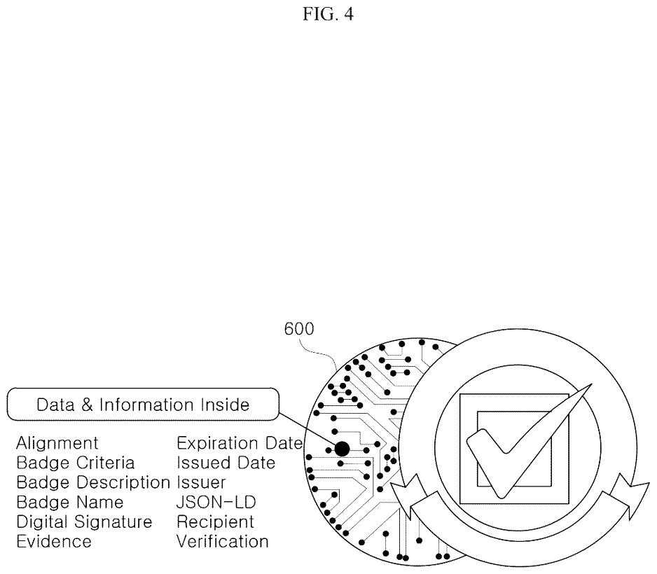

FIG. 4 is a diagram illustrating the concept of a learning map-linked open badge, according to an embodiment of the present disclosure.

First of all, an open badge 600 may be issued, obtained, and managed through an open badge platform that supports an open badge standard. As shown in FIG. 4, the open badge 600 includes information about content of guaranteed skills, issuer information, user information thus obtained and displayed, expiration date, a method for verification, or the like. The open badge 600 may also be approached from an ecological perspective. Major stakeholders may be classified into three types: an issuance institution that issues the open badge 600, a user that obtains the badge, and a company that develops an open badge platform.

First of all, the open badge 600 determines whether to be issued, as qualifications are assigned by a learning institution. The learning institution may divide learning into small chunks to provide the small chunks to a user, may credential the learning based on proficiency, may grant an issuance qualification for the open badge as a means of recognition for microcredentials, and may measure and maintain the user's abilities (talent, qualifications).

Moreover, the user who receives the open badge 600 may submit (present) the open badge as evidence of the skills or academic achievements, which he/she has learned, to go on to an advanced school or to find a job, may make a request for issuance information to an issuer when the open badge is issued to the user, may collect the open badge 600 in a portfolio or backpack to provide a notification of his/her story, and may share his/her open badge 600 with social media or the community. That is, the open badge 600 may be posted on at least one SNS at the request of the user terminal 100.

Moreover, the company that finds business opportunities may design a system capable of recognizing and verifying small chunks of learning provided by learning institutions, may develop a tool for tracking the user's engagement levels, extending resources, creating the open badge 600, and displaying/hosting the open badge, may apply an open badge standard, and may obtain conformity certification.

Meanwhile, the open badge 600 may include an issuer, a badge class, and an assertion. Here, the assertion may include performance information about the history performed by the corresponding user.

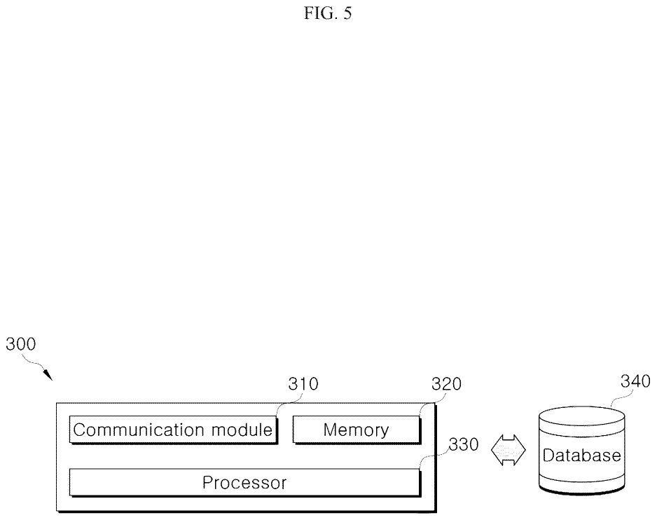

FIG. 5 is a diagram showing a configuration of a service server that provides a learning curation service using a learning map-linked open badge, according to an embodiment of the present disclosure.

Referring to FIG. 5, according to an embodiment of the present disclosure, the service server 300 that provides a learning curation service using a learning map-linked open badge may include a communication module 310, a memory 320, and a processor 330.

The communication module 310 may perform wired or wireless communication with at least one external device (a server, etc.), external storage (e.g., a database 340), an external server, and at least one cloud server as well as the user terminal 100, the first institutional terminal 200, and the second institutional terminal 400. In particular, when the wireless communication is performed, wireless signals are exchanged over a communication network based on wireless Internet technologies.

In the meantime, the external server or the cloud server may be configured to perform at least part of the role of the processor 330. In other words, data processing or data operations may be performed by an external server or a cloud server, and the present disclosure does not place any special restrictions on this method.

The communication module 310 may include one or more components that enable communication with an external device. The communication module 310 may include, for example, at least one of a wired communication module, a wireless communication module, and a short-range communication module, and may transmit and receive signals based on the at least one communication module.

Here, in addition to various wired communication modules such as a Local Area Network (LAN) module, a Wide Area Network (WAN) module, or a Value Added Network (VAN) module, the wired communication module may include a variety of cable communication modules such as Universal Serial Bus (USB), High Definition Multimedia Interface (HDMI), Digital Visual Interface (DVI), recommended standard (RS-232), power line communication, or plain old telephone service (POTS).

In addition to a Wi-Fi module and a Wireless broadband (WiBro) module, the wireless communication module may include a wireless communication module that supports various wireless communication methods such as global System for Mobile Communication (GSM), Code Division Multiple Access (CDMA), Wideband Code Division Multiple Access (WCDMA), universal mobile telecommunications system (UMTS), Time Division Multiple Access (TDMA), Wireless LAN (WLAN), Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), 4G, 5G, 6G, or the like.

The short-range communication module may be used for short range communication, and may support short-range communication by using at least one of Bluetooth™, radio frequency identification (RFID), infrared data association (IrDA), ultra wideband (UWB), ZigBee, near field communication (NFC), Wireless-Fidelity (Wi-Fi), Wi-Fi Direct, and wireless universal serial bus (Wireless USB) technologies.

In particular, the communication module 310 may receive a request for issuance, authentication, or the like of an open badge from each of the user terminal 100, the first institutional terminal 200, and the second institutional terminal 400 based on wired or wireless communication and may transmit the result for the request. Furthermore, various types of information for issuing and authenticating the open badge may be exchanged with the user terminal 100, the first institutional terminal 200, and/or the second institutional terminal 400 through the communication module 310. In addition, the communication module 310 exchanges various types of information with at least one external device.

The memory 320 stores data and/or various types of information for supporting various functions of the service server 300. The memory 320 may store a plurality of application programs (or applications) running in the service server 300, data for an operation of the service server 300, and instructions. At least part of the application programs may be downloaded from an external server through wireless communication. In the meantime, the application program may be stored in at least one memory provided in the memory 320, may be installed in the service server 300, and may be driven so as to perform an operation (or function) executed by at least one processor provided in the processor 330.

In the meantime, the at least one memory may include a storage medium of at least one type of a flash memory type, a hard disk type, a multimedia card micro type, a card type memory (e.g., SD memory, XD memory, etc.), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, etc. Besides, the memory may store information temporarily, permanently, or semi-permanently, and may be provided in an embedded type or a removable type.

The memory 320 may establish and store a database 340 for providing a learning curation service. The database 340 may store various pieces of information about at least one respective user (a recipient, an educational institution, a receiving institution, or the like) subscribed to the learning curation service. Moreover, the memory 320 may store at least one process for providing the learning curation service.

The processor 330 may include at least one processor for providing the learning curation service. The processor 330 may allow all components within the service server 300 to process signals, data, information, or the like, which is input or output, or may perform various processes by executing commands, algorithms, and application programs stored in at least one memory.

That is, all operations performed by the service server 300 described above based on FIGS. 1 and 2 may be performed under control of the processor 330.

In detail, when an open badge issuance request is received from the user terminal 100, the processor 330 determines whether to issue the open badge by determining whether a user possesses the eligibility to receive the requested open badge. Subsequently, when the open badge issuance is completed based on the determination, the processor 330 records and manages the issued open badge in the user's DID electronic wallet registered on a blockchain.

Meanwhile, the processor 330 generates and provides learning curation information for open badges issued based on pre-stored curriculum information.

In this case, the pre-stored curriculum information includes a competency framework for each curriculum, and at least one related competency framework may be configured to be interconnected. In addition, the competency framework may include a learning map in which at least one competency item included in the corresponding curriculum is structured in the order of a learning stage, a learning area, a learning topic, and an achievement standard and is connected step by step, and at least one related competency item may be configured to be interconnected. Here, the competency item may represent a learning goal or a learning competency and include learning content, and may be configured to include at least one sub-competency item.

Furthermore, the processor 330 may collect the user's learning information from at least one learning institution and, may generate specialized learning curation information more suitable for the user in consideration of this. Here, the learning information may include at least one of a learning level, a learning history, a test history, learning results, test results, a learning time, a learning rate, and a progress rate during a preset period. For example, the processor 330 may determine whether to proceed to a higher learning stage or a lower learning stage, by determining whether the user's learning is excellent or poor although the user is in the first grade of elementary school, based on at least one variable included in the learning information. Moreover, when the learning time required for the user to receive the issuance of an open badge is greater than an average learning time, the processor 330 may determine to repeat the same learning stage. In this case, a long learning time may indicate that the user has lost interest in learning, and thus the processor 330 may search for popular learning content corresponding to the learning stage from at least one search server and may include information about that popular learning content in the learning curation information so as to be provided. Here, the popular learning content may be determined based on views, chats, the number of repeated viewings, likes, etc. However, this is only one example, and learning curation information specialized for the user may be generated by complexly using at least one variable.

In the meantime, when a DID user registration request is received from the user terminal 100, the processor 330 performs DID registration on a blockchain by verifying user identity through integrated authentication (biometric authentication, PIN number, and patterns) while issuing a first distributed ID.

In the meantime, when an open badge issuance request for the corresponding user is received from the user terminal 100, after the processor 330 performs user authentication by accessing a distributed ID based on one of a plurality of authentication methods, the processor 330 provides an issuable open badge list including at least one issuable open badge for the corresponding user. When one of the open badges is selected from the issuable open badge list, the processor 330 issues an open badge by identifying and combining the history data and format based on a DID electronic wallet of the corresponding user registered in the blockchain.

Moreover, when a DID verification request for a previously issued open badge is received from the user terminal 100 or the second institutional terminal 400, the processor 330 performs user authentication by accessing the distributed ID based on one of the plurality of authentication methods and performs DID verification on the previously issued open badge based on the DID electronic wallet of the corresponding user registered in the blockchain.

In this case, when the processor 330 performs DID verification, the processor 330 may verify badge issuance data by using a hash value of an open badge (an open badge for which DID verification is requested) thus previously issued, and a hash value of the open badge previously registered in the blockchain. Here, the hash value of the previously issued open badge may be obtained based on a public key used to sign the digitally signed assertion on the open badge.

The processor 330 may perform DID verification based on the linked API.

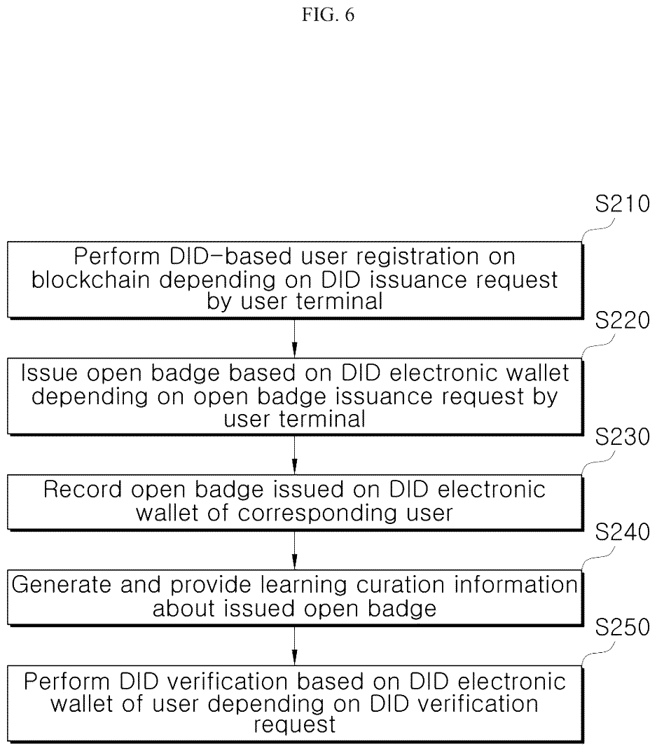

FIG. 6 is a flowchart illustrating a method for providing a learning curation service using a learning map-linked open badge, according to an embodiment of the present disclosure.

Referring to FIG. 6, a user performs DID user registration on a blockchain to the service server 300 by transmitting a DID user registration request by using the user terminal 100 to receive a learning curation service (S210).

Next, when the user terminal 100 requests the issuance of an open badge by selecting an issuance item, the service server 300 issues the open badge based on a DID electronic wallet of the corresponding user through the linked API (S220).

Next, the service server 300 records the previously issued open badge in a corresponding user's DID electronic wallet registered on the blockchain (S230) and generates and provides learning curation information about the issued open badge based on the pre-stored curriculum information (S240).

Additionally, when a DID verification request for the open badge thus previously issued is received from the user terminal 100 or the second institutional terminal 400, the service server 300 performs DID verification on the open badge based on the DID electronic wallet of the corresponding user through the previously linked API (S250).

Here, step S250 may not be a necessary operation and may be optionally performed as needed.

In the meantime, although not shown in FIG. 6, the service server 300 may register at least one issuer in or before step S210. In this case, the system, format, or the like for qualifications, certificates, or the like credentialed by each first institution may be stored together.

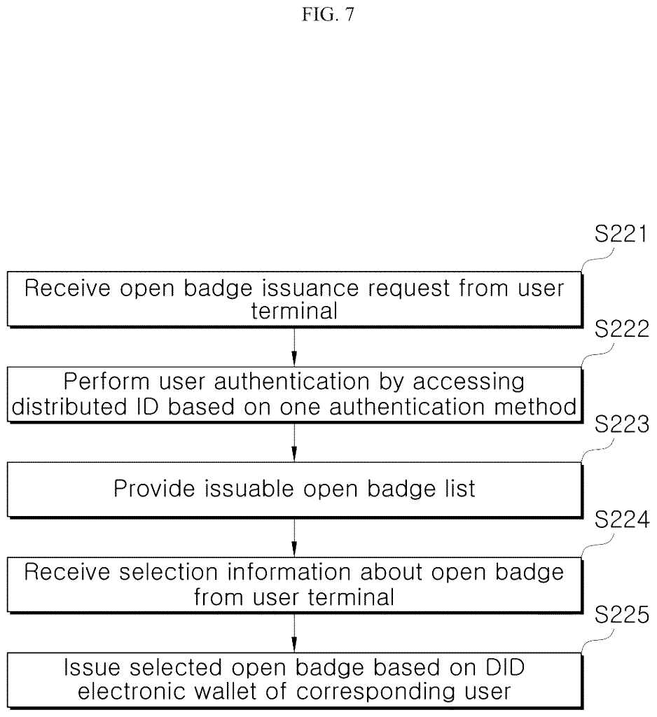

FIG. 7 is a diagram showing a specific operation for issuing an open badge in a method for providing a learning curation service using a learning map-linked open badge, according to an embodiment of the present disclosure.

Referring to FIG. 7, when an open badge issuance request for the corresponding user is received from the user terminal 100 (S221), the service server 300 performs user authentication by accessing a distributed ID based on one of a plurality of authentication methods (S222).

Next, the service server 300 provides an issuable open badge list including at least one issuable open badge for the corresponding user (S223). When selection information generated as a user selects one open badge from the issuable open badge list is received through the user terminal 100 (S224), the service server 300 issues the selected open badge by identifying and combining the history data and format based on a DID electronic wallet of the corresponding user, which is registered in a blockchain (S225).

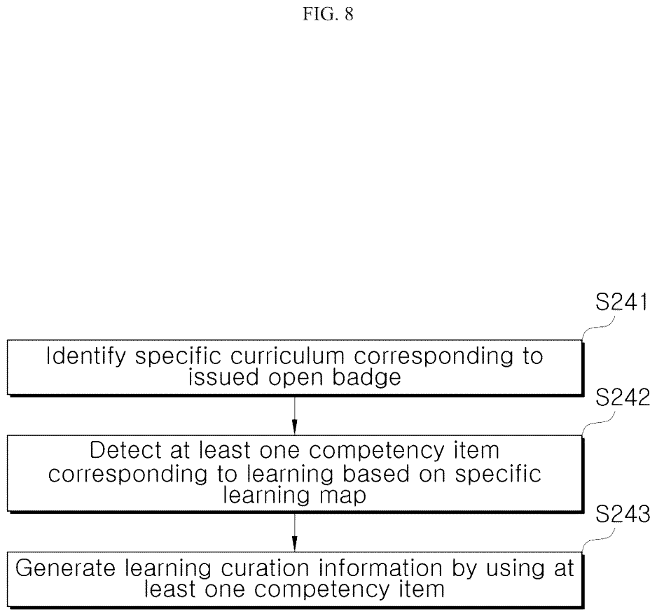

FIG. 8 is a diagram illustrating a specific operation for generating learning curation information in a method for providing a learning curation service using a learning map-linked open badge, according to an embodiment of the present disclosure.

Referring to FIG. 8, the service server 300 identifies a specific curriculum corresponding to the open badge issued in step S220 from the pre-stored curriculum information (S241).

Next, the service server 300 detects at least one competency item corresponding to the corresponding learning based on a specific learning map included in the competency framework of the specific curriculum (S242).

Next, the service server 300 generates learning curation information by using the at least one competency item detected in step S242 (S243). In particular, the service server 300 may generate learning curation information by identifying a specific curriculum corresponding to the previously issued open badge in the pre-stored curriculum information, and detecting at least one competency item corresponding to the corresponding learning based on a specific learning map included in the competency framework of the identified specific curriculum.

Furthermore, the service server 300 may search for learning corresponding to the at least one competency item from the database 340 or an external device (server), and may include learning information, learning materials and/or learning content according to the search results so as to be provided to the user terminal 100.

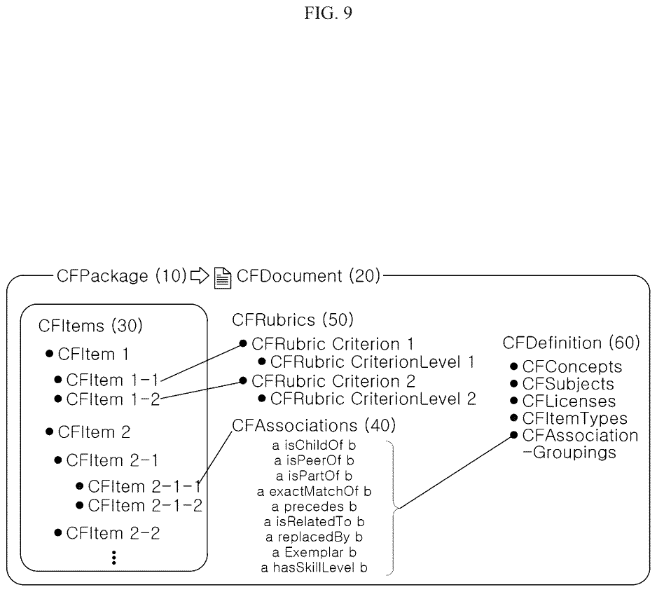

FIG. 9 is a diagram showing a detailed structure of a competency framework corresponding to each curriculum, according to an embodiment of the present disclosure.

Referring to FIG. 9, a competency framework corresponding to each curriculum is a systematically organized set of knowledge and skills that a user needs to learn. The competency framework is a top-level document that defines curricula, achievement standards, and competencies included in the pre-stored curriculum information, i.e., the overall curriculum information, and comprehensively covers the competencies/standards of specific subjects or the entire curricula. All competency skills may depend on each competency framework (20), and each competency framework (20) may include at least one competency item (30) thereunder. Here, the competency framework and the competency item may be referred to as CFDocument and CFItem, respectively.

In particular, CFItems (30), CFAssociations (40), CFRubrics (50), and CFDefinition (60) may be included as components in CFDocument (20).

First of all, CFDocument (20) may include at least one of an identifier, a title, a creator, a URI, a subject, a description, main competencies, and lastChangeDataTime as metadata. Moreover, CFDocument (20) may include at least one of subjectURI, a language, a version, a current status, a publication start date, a publication conversion date, a license URI, an additional description, and a reference.

Table 1 below describes the descriptions for each of a plurality of variables capable of being included in metadata of the competency framework (20).

TABLE 1

| | | | Required or |
|---|---|---|---|
| Variable | Type | Descriptions | not |
| Identifier | UUID | Unique identifier | Required |
| uri | URI | Unique address for finding CFD on | Required |
| | | Internet | |
| creator | String | Name of institution that creates and | Required |
| | | approves competency framework | |
| | | e.g., Office of Education, University, | |
| | | etc. | |
| title | String | Title of CFDocument | Required |
| lastChangeDateTime | Date Time | Date and time at point in time when | Required |
| | | CFDocumentrk was last modified | |
| OfficialSourceURL | URL | Web address (URL) of | Optional |
| | | standard/competency document | |
| | | (original) | |
| publisher | String | Name of institution that publicly | Optional |
| | | publishes and distributes | |
| | | curriculum/competency documents | |
| description | String | Brief description of content | Optional |
| | | contained in CFDocument | |
| subject | String list | Keywords representing subject or | Optional |
| | | field of CFDocument | |
| | | e.g., Math or Science | |
| language | String in ISO | Language in which content of | Optional |
| | 639-2 format | CFDocument is written | |
| | | Typically using language codes in | |
| | | ISO 639-2 format | |
| version | String | CFDocumentdml version | Optional |
| | | information | |
| adoptionStatus | String | Date and time at point in time when | Optional |
| | | CFDocumentrk was last modified | |
| statusStartDate | Date | Date at point in time when | Optional |
| | | CFDocument was first published | |
| statusEndDate | Date | Date at point in time when | Optional |
| | | CFDocument was unpublished or | |
| | | converted to another value | |
| licenseURI | LinkURI | Address of web document including | Optional |
| | | license information related to usage | |
| | | permissions of CFDocument | |
| notes | String | Additional descriptions or reference | Optional |
| | | materials regarding CFDocument | |

Meanwhile, CFItems (30) are individual items that constitute competency/standards within CFDocument (20), and indicate specific learning content, learning objectives, and achievement standards by breaking down CFDocument (20) into smaller units.

Here, CFItems (30) may include a plurality of CFItems and may be arranged based on the relationships between CFItems. That is, CFItems (30) may be structured in the order of learning stages, learning areas, learning topics, and achievement standards, and connected step-by-step, and thus may have the form of a learning map.

In this case, one or more CFItems may be present under CFDocument (20), and CFItems of several depths may be added thereunder.

CFItems (30) may include at least one of an identifier, a full statement regarding competencies and curricula, a URI (reference URI for the item), and a lastChangeData Time as metadata. Furthermore, CFItems (30) may include other metadata, and the types and number of data are not limited thereto.

CFAssociations (40) play an essential role in defining and expressing the relationships between components of CFDocument (20), which represent the relationships between the entire curriculum and achievement standards, competency sets, or individual items and courses.

These CFAssociations (40) may be formed between pieces of CFDocument (20) or between pieces of CFItem (30), and may also be formed between CFDocument (20) and CFItem (30). Moreover, the components connected to CFAssociations (40) may be present within a single curriculum or may be external components.

Table 2 below describes the relationship types related to CFAssociations (40).

TABLE 2

| Relationship type | Descriptions |
|---|---|
| isChildOf | Source node is child of destination node |
| isPeerOf | Source node and destination node are equivalent |
| isPartOf | Source node is part of destination node and is logically |
| | or semantically included therein. |
| exactMatchOf | Source node and destination node match exactly |
| Precedes | Source node temporally precedes destination node |
| isRelatedTo | Using it when source and destination nodes are related |
| | but may not be better described in a different type |
| replacedBy | Source node is replaced with destination node |
| Exemplar | Destination node is example of source node |
| hasSkillLevel | Destination node represents technical level of source |
| | node |

In addition, CFRubrics (50) is one of the core elements, is a component that defines how to evaluate whether competency is achieved, includes evaluation criteria of different grades, and thus is used to describe the quality of learning tasks, works, and learning performance. It defines both the description of evaluation scales and the determination basis of different evaluation grades. In this case, CFRubrics (50) logically takes a matrix structure. Here, rows of a matrix are used to define evaluation criteria (CFRubricCriterion), and columns of the matrix are used to define several different levels (CFRubricCriterionLevel) under each evaluation criterion.

This CFRubric may be composed of CFRubricCriterion and CFRubricCriterionLevel. For example, each CFRubricCriterion may have an achievement standard level, and a rubric criterion weight may be assigned. Also, CFRubricCriterionLevel specifically describes the extent of a student's performance regarding an achievement level, and a level-specific description for each achievement level and a score according to an achievement level are assigned.

In the meantime, CFRubric is organically linked with other elements. CFRubricCriterion is linked to CFItem to implement the competencies and achievement criteria set in a curriculum as an assessment tool and measure the competency achievement level of a learner.

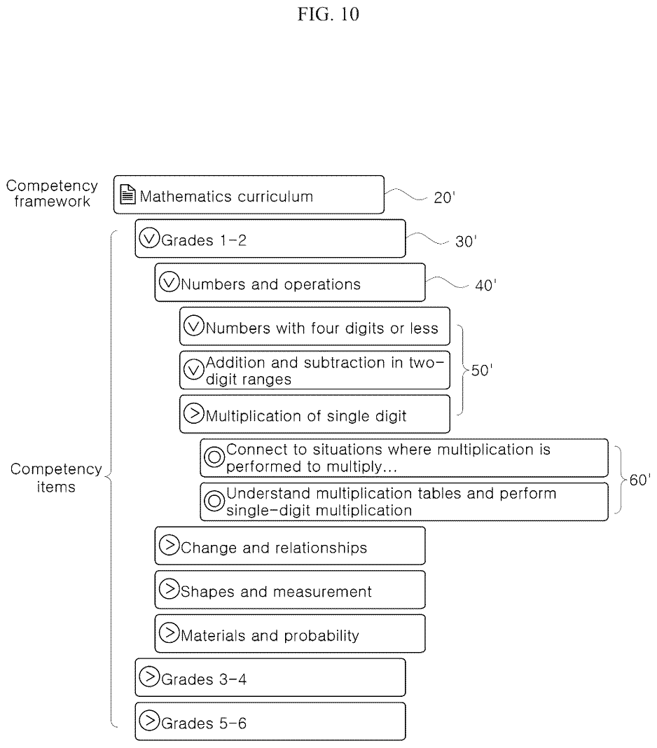

FIG. 10 is a diagram showing an example of a competency framework corresponding to a specific curriculum, according to an embodiment of the present disclosure.

Referring to FIG. 10, at the top of the learning map, there is a competency framework 20′ representing the entire curriculum, and a grade (level) 30′, a learning area 40′, a learning element 50′, and an achievement standard 60′ may be connected stepwise in the form of competency items thereunder.

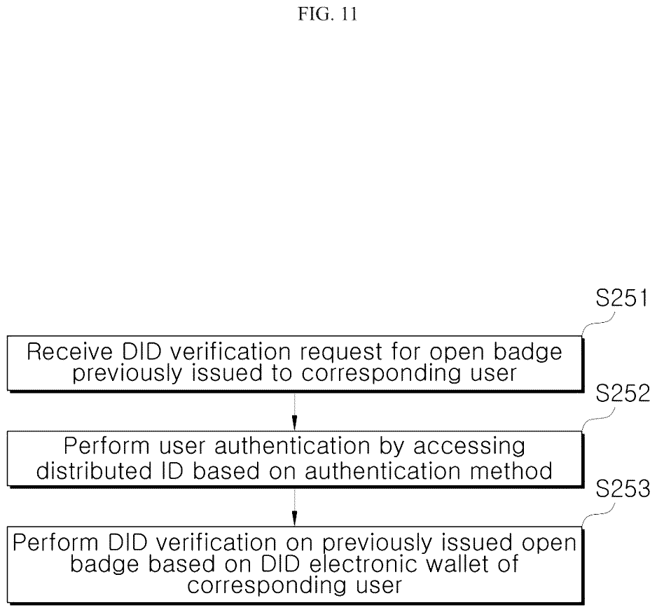

FIG. 11 is a diagram showing a specific operation for performing DID verification in a method for providing a learning curation service using a learning map-linked open badge, according to an embodiment of the present disclosure.

Referring to FIG. 11, when a DID verification request for an open badge previously issued to the corresponding user is received from the user terminal 100 or the second institutional terminal 400 (S251), the service server 300 performs user authentication by accessing a distributed ID based on one of a plurality of authentication methods (S252).

Next, the service server 300 performs DID verification on the previously issued open badge, for which verification is requested in step S251, based on a DID electronic wallet of the corresponding user, which is registered in a blockchain (S253).

In this case, step S253 may be used to verify badge issuance data by using a hash value of an open badge (an open badge for which DID verification is requested) thus previously issued, and a hash value of the open badge previously registered in the blockchain. Here, the hash value of the previously issued open badge may be obtained based on a public key used to sign the digitally signed assertion on the open badge.

The above-described program may include a code encoded by using a computer language such as C, C++, JAVA, a machine language, or the like, which a processor (CPU) of the computer may read through the device interface of the computer, such that the computer reads the program and performs the methods implemented with the program. The code may include a functional code related to a function that defines necessary functions executing the method, and the functions may include an execution procedure related control code necessary for the processor of the computer to execute the functions in its procedures. Furthermore, the code may further include a memory reference related code on which location (address) of an internal or external memory of the computer should be referenced by the media or additional information necessary for the processor of the computer to execute the functions. Further, when the processor of the computer is required to perform communication with another computer or a server in a remote site to allow the processor of the computer to execute the functions, the code may further include a communication related code on how the processor of the computer executes communication with another computer or the server or which information or medium should be transmitted/received during communication by using a communication module of the computer.

The stored medium refers not to a medium, such as a register, a cache, or a memory, which stores data for a short time but to a medium that stores data semi-permanently and is read by a device. In detail, for example, the stored medium may include a read only memory (ROM), a random access memory (RAM), a CD-ROM, a magnetic tape, a floppy disk, and an optical data storage device, but the present disclosure is not limited thereto. That is, the program may be stored in various recording media on various servers that the computer may access, or various recording media on the computer of the user. In addition, the media may be distributed to a computer system connected to a network, and a computer-readable code may be stored in a distributed manner.

Steps or operations of the method or algorithm described with regard to an embodiment of the present disclosure may be implemented directly in hardware, may be implemented with a software module executable by hardware, or may be implemented by a combination thereof. The software module may reside in a random access memory (RAM), a read only memory (ROM), an erasable programmable ROM (EPROM), an electrically erasable programmable ROM (EEPROM), a flash memory, a hard disk, a removable disk, a CD-ROM, or a computer-readable recording medium well known in the art to which the present disclosure pertains.

Although an embodiment of the present disclosure are described with reference to the accompanying drawings, it will be understood by those skilled in the art to which the present disclosure pertains that the present disclosure may be carried out in other detailed forms without changing the scope and spirit or the essential features of the present disclosure. Therefore, the embodiments described above are provided by way of example in all aspects, and should be construed not to be restrictive.

According to the above-mentioned problem solving means of the present disclosure, it is possible to reduce a user's trouble of generally visiting an educational institution or the educational institution's homepage to obtain a certificate, an educational qualification, or the like and submitting it directly to consumers (submitting institutions), by issuing and providing a blockchain-based open badge linked to the user's academic achievement such that the user (learner) is capable of proving his/her qualifications acquired through education, learning, examination, or the like provided by the educational institution (learning institution), thereby reducing the time required for issuance and submission as well as incidental costs while security is guaranteed.

In the meantime, according to an embodiment of the present disclosure, it is possible to allow a user to easily check the user's fragmented history data by integrating and managing at least one open badge issued to the user, and to allow the user to post the fragmented history data to at least one SNS, thereby quickly and easily utilize the history data for employment or advancement.

In the meantime, according to an embodiment of the present disclosure, by providing a learning curation service using an open badge based on a learning map, the user is capable of gradually and systematically expanding his/her capabilities.

Effects of the present disclosure are not limited to the effects mentioned above, and other effects not mentioned will be apparent by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A learning curation service providing system using a learning map-linked open badge, the system comprising:
a first institutional terminal configured to provide a learning service to a user terminal, and to create or update history information about a user by receiving learning performance result information from the user terminal;
the user terminal configured to perform learning through a learning service provided by the first institutional terminal, and to store an open badge issued upon requesting a service server to issue an open badge for the learning; and
the service server configured to:
when an open badge issuance request is received from the user terminal, determine whether to issue the open badge, by determining whether the user has an issuance qualification for the open badge requested to be issued;
when open badge issuance is completed, record and manage the issued open badge on a decentralized identifiers (DID) electronic wallet of the user registered on a blockchain; and
generate and provide learning curation information about the issued open badge based on pre-stored curriculum information.

2. The system of claim 1, wherein the pre-stored curriculum information includes a competency framework for each curriculum, and at least one related competency framework is configured to be interconnected, and
wherein the competency framework includes a learning map in which at least one competency item included in a corresponding curriculum is structured in an order of a learning stage, a learning area, a learning topic, and an achievement standard and is connected step by step, and the at least one related competency item is configured to be interconnected.

3. The system of claim 2, wherein the competency item represents a learning goal or a learning competency, includes learning content, and includes at least one sub-competency item.

4. The system of claim 3, wherein the service server is configured to:
generate the learning curation information by identifying a specific curriculum corresponding to the issued open badge in the pre-stored curriculum information, and detecting at least one competency item corresponding to the learning based on a specific learning map included in a competency framework of the specific curriculum.

5. The system of claim 4, wherein the service server is configured to:
search for at least one associated learning corresponding to the at least one competency item; and
determine and place a learning order based on an inclusion relationship with the found at least one associated learning to generate the learning curation information.

6. The system of claim 2, wherein the competency framework includes at least one of an identifier, a title, a creator, a URI, a subject, a description, main competencies, and a last-change-data-time as metadata.

7. The system of claim 1, wherein the service server is linked to the first institutional terminal based on an application programming interface (API) to perform at least one of DID user registration, open badge issuance, and DID verification on the corresponding user.

8. The system of claim 1, further comprising:
a second institutional terminal configured to determine whether the corresponding user is qualified for the learning, by making a request for verification of the issued open badge to the service server when the issued open badge is submitted from the user terminal.

9. The system of claim 8, wherein the service server is configured to:
perform DID verification on the issued open badge based on a DID electronic wallet of the corresponding user registered in the blockchain when a DID verification request for the issued open badge is received from the second institutional terminal.

10. A method performed by a device and used to provide a learning curation service using a learning map-linked open badge, the method comprising:
when a corresponding user completely performs learning based on a learning service provided by a first institutional terminal, transmitting, by a user terminal, learning performance result information about the learning to a first institutional terminal;
generating or updating, by the first institutional terminal, history information about the corresponding user based on the learning performance result information;
when an open badge issuance request for the learning is received from the user terminal, determining, by a service server, whether the corresponding user has an issuance qualification for the open badge requested to be issued, through the first institutional terminal;
when the determination result indicates that the corresponding user has the issuance qualification for the open badge requested to be issued, issuing, by the service server, an open badge for the learning based on badge issuance data for the corresponding user;
recording, by the service server, the issued open badge in a DID electronic wallet of the corresponding user registered on a blockchain; and
generating and providing, by the service server, learning curation information about the issued open badge based on pre-stored curriculum information.
